(19) United States
(12) Patent Application Publication
(10) Pub. No.: US 2013/0140979 A1
(43) Pub. Date: Jun. 6, 2013

(54) PLASMA TUBE ARRAY-TYPE DISPLAY DEVICE

(71) Applicant: Shinoda Plasma Co., Ltd., Kobe-shi (JP)

(72) Inventors: Yoshiro MORITA, Kobe (JP); Hitoshi HIRAKAWA, Kobe (JP); Bingang GUO, Kobe (JP); Hajime TANAKA, Kobe (JP); Norihisa DAN, Kobe (JP)

(73) Assignee: Shinoda Plasma Co., Ltd., Kobe-shi (JP)

(21) Appl. No.: 13/687,458

(22) Filed: Nov. 28, 2012

(30) Foreign Application Priority Data
Dec. 2, 2011 (JP) 2011-264311

(51) Int. Cl. H01J 17/49

(52) U.S. Cl. CPC H01J 17/49
USPC 313/487; 313/582

(57) ABSTRACT

A plasma tube array-type display device has an improved high resolution and sufficient brightness. In the plasma tube array-type display device comprising a plasma tube array that includes a plurality of plasma tubes 31, 31, . . . arranged in parallel, each plasma tube 31 has a transverse section orthogonal to the longitudinal direction of a vertically long, flattened shape having its longer diameter vertically, and the plurality of plasma tubes 31, 31, . . . are arranged to adjoin each other by their tube walls of longer diameter side.

### BACKGROUND OF THE INVENTION

1. Field of the Invention

The present invention relates to a plasma tube array-type display device including a plurality of plasma tubes arranged in parallel. Particularly, the present invention relates to a plasma tube array-type display device having an improved high resolution (high density) and sufficient brightness.

2. Description of the Related Art

Plasma tube array-type display devices have been developed as a technology for providing new-generation large-screen display devices. They each include a plurality of plasma tubes filled with a discharge gas that are arranged in parallel. For example, the plasma tube array-type display device is constructed as a film display device in which 1000 plasma tubes or more with a length of 1 to 2 meters are arranged in parallel. Furthermore, for example, the plasma tube array-type display device of one meter square is used as a sub-module, a plurality of sub-modules are connected to one another to expand the screen size arbitrarily. In this manner, a supersized plasma tube array-type display device characterized by a flexible film screen can be constructed. Since such a configuration allows a thin glass tube to be used as a production unit, no large-scale equipment is required to handle large glass substrates that are necessary in manufacturing large-sized display panels such as LCDs and PDPs. This facilitates, for example, transportation and installation and thereby supersized display devices can be provided at a lower cost.

The configuration of the plasma tubes, with which a plasma tube array is configured, is disclosed in JP 2003-068214 A (U.S. Pat. No. 6,677,704B). JP 2003-068214 A (U.S. Pat. No. 6,677,704B) discloses the configuration of a plasma tube having a horizontally long, flattened elliptical transverse section and a ratio of the longer and shorter diameters in the range of 10:7 to 5:1. Furthermore, JP 2003-286043 A (US 2003/182967A) discloses a method for manufacturing a flat elliptical glass thin tube.

In a plasma tube array-type display device, the pixel size is determined by the longer diameter of the transverse section of the elliptical plasma tube. However, in the case of the configuration of the plasma tube disclosed in JP 2003-068214 A (U.S. Pat. No. 6,677,704B), it is very difficult to make the high-resolution display with a pixel size of 3 mm or less, because the shorter diameter in a vertical direction becomes extremely short if the longer diameter is shortened according to the pixel size. This results in a decrease in the amount of phosphors in the phosphor layer formed on an inner wall of the plasma tube and thereby the display device cannot maintain sufficiently high brightness, which has been a problem.

### SUMMARY OF THE INVENTION

The present invention is intended to improve the resolution of a plasma tube array-type display device including a plurality of plasma tubes arranged in parallel. More particularly, the present invention is intended to provide a plasma tube array-type display device that can maintain sufficiently high brightness even when the resolution is increased. In order to achieve the above-mentioned object, a plasma tube array-type display device according to a first invention comprises a plasma tube array that includes a plurality of plasma tubes arranged in parallel, a plurality of address electrodes each provided along a longitudinal direction of the respective plasma tube, and a plurality of display electrodes extending in a direction crossing the plasma tubes, wherein each of the plasma tubes has a transverse section with longer diameter and shorter diameter of a vertically long flattened shape in an orthogonal plane to a longitudinal direction of the plasma tube, and they are arranged to adjoin each other by their tube walls of longer diameter side, to be in contact with the address electrodes by one side of the tube walls of shorter diameter side along the longitudinal direction, and to be in contact with the display electrodes by the other side of the tube walls of shorter diameter side, which is opposite to the one side.

A plasma tube array-type display device according to a second invention is characterized in that in the first invention, the plasma tubes each have the transverse section orthogonal to the longitudinal direction of a vertically long, flattened, pseudo-octagonal shape with four flat surfaces and four curved surfaces connecting the four flat surfaces, respectively, where the four flat surfaces include a first shorter diameter side flat surface that is in contact with the address electrode, a second shorter diameter side flat surface that is in contact with the display electrode, and third and fourth longer diameter side flat surfaces that are opposed to each other in an arranging direction of the plasma tubes.

A plasma tube array-type display device according to a third invention is characterized in that in the second invention, each of the plasma tubes with the transverse section of the vertically long, flattened, pseudo-octagonal shape have the first shorter diameter side flat surface narrower in width than the second shorter diameter side flat surface in the transverse section orthogonal to the longitudinal direction.

A plasma tube array-type display device according to a fourth invention is characterized in that in the first or second invention, the plasma tubes each have a transverse section orthogonal to the longitudinal direction of a substantially vertically long, flattened, trapezoidal shape, a plasma tube set is composed in such a manner that a red plasma tube containing a red (R) phosphor on a narrower top side inner surface which is arranged downward, a blue plasma tube containing a blue (B) phosphor on a wider bottom side inner surface, and a green plasma tube containing a green (G) phosphor on a narrower top side inner surface which is arranged downward, are arranged to adjoin one another with respective phosphors being located on the same side, and a plurality of plasma tube sets are arranged to compose the plasma tube array.

A plasma tube array-type display device according to a fifth invention is characterized in that in any one of the first to fourth inventions, the plasma tubes each comprise a phosphor support member inserted in a glass tube having a transverse section of a vertically long, flattened shape, which supports the red (R), green (G) or blue (B) phosphor, and the phosphor support member has a U-shaped cross section that has an opening at a position higher than two-thirds the height from the bottom surface of the glass tube.

Furthermore, a plasma tube array-type display device according to a sixth invention is characterized in that in the first or second invention, a shorter diameter a of the transverse section of each of the plasma tubes in the arranging direction of the plasma tubes is 1 mm or less, and the shorter diameter a and a longer diameter b have a relationship of 3a>b>a.

In order to achieve the above-mentioned object, a plasma tube array-type display device according to a seventh invention comprises a plurality of plasma tubes arranged in parallel, each of which has a shape of flattened, vertically long cross section with a shorter diameter side opposed to two flat surfaces and a longer diameter side opposed to two flat surfaces in an orthogonal plane to a longitudinal direction of the plasma tube, wherein a first shorter diameter side flat surface of the plasma tube contacts with address electrodes, a second shorter diameter side flat surface of the plasma tube contacts with a plurality of display electrodes, and the third and fourth longer diameter side flat surfaces of the plasma tube are arranged adjoining with the longer diameter side flat surfaces of the other plasma tubes in arranging direction.

Furthermore, a plasma tube array-type display device according to a eighth invention is characterized in that in the seventh invention, a shorter diameter a of the transverse section of each of the plasma tubes in the arranging direction of the plasma tubes is 1 mm or less, and the shorter diameter a and a longer diameter b have a relationship of 3a>b>a.

As described above, the plasma tubes each has a transverse section orthogonal to the longitudinal direction of a vertically long, flattened shape having its longer diameter vertically, and they form a plasma tube array in which they are arranged to adjoin each other by their tube walls of longer diameter side. This makes it possible to reduce the size in width of the plasma tubes in the arranged direction of the plasma tubes without reducing the volume of the discharge space, which allows the resolution to be improved. Moreover, since the amount of phosphors in the phosphor layers that are formed inside the plasma tubes also is substantially not reduced, it is possible to obtain high resolution with a pixel size of 3 mm or less while maintaining a certain brightness.

### BRIEF DESCRIPTION OF THE DRAWINGS

FIG. 1 is a perspective view schematically showing the configuration of a plasma tube array-type display device according to Embodiment 1 of the present invention.

FIG. 2 is an enlarged perspective view partially showing the configuration of the plasma tube array of the plasma tube array-type display device according to Embodiment 1 of the present invention.

FIG. 3 is a cross-sectional view taken at a plane orthogonal to the longitudinal direction of a plasma tube of the plasma tube array-type display device according to Embodiment 1 of the present invention. FIGS. 4A, 4B and 4C each are an illustration showing a step of producing the glass tube envelope for the plasma tube of the plasma tube array-type display device according to Embodiment 1 of the present invention.

FIG. 5 is a cross-sectional view taken at a plane orthogonal to the longitudinal direction of the plasma tube of the plasma tube array-type display device according to Embodiment 1 of the present invention, in the case of using a phosphor support.

FIG. 6 is a cross-sectional view taken at a plane orthogonal to the longitudinal direction of a plasma tube of a plasma tube array-type display device according to Embodiment 2 of the present invention.

FIGS. 7A, 7B and 7C each are an illustration showing a step of producing the glass tube envelope for the plasma tube of the plasma tube array-type display device according to Embodiment 2 of the present invention.

FIG. 8 is a cross-sectional view schematically showing the configuration of a plasma tube set of a plasma tube array-type display device according to Embodiment 3 of the present invention.

### BEST MODE FOR CARRYING OUT THE INVENTION

Hereinafter, plasma tube array-type display devices according to embodiments of the present invention are described in detail with reference to the drawings.

### Embodiment 1

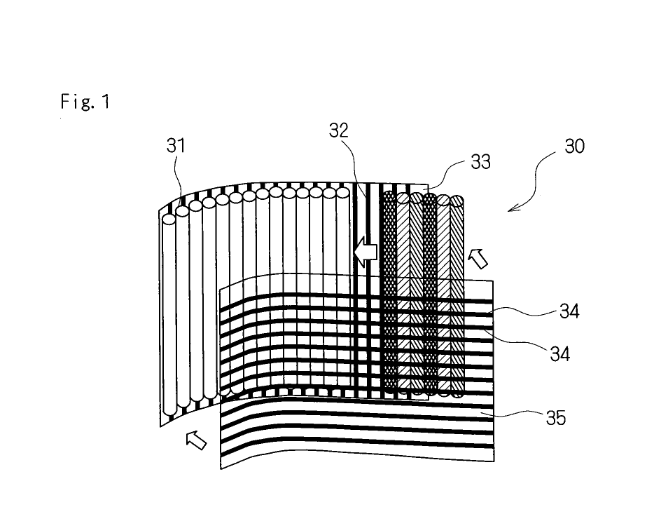

FIG. 1 is a perspective view schematically showing the configuration of a plasma tube array-type display device according to Embodiment 1 of the present invention. As shown in FIG. 1, the plasma tube array-type display device 30 according to Embodiment 1 includes a plurality of plasma tubes 31, 31, . . . arranged in parallel, each of which is filled with a discharge gas. The plasma tubes 31, 31, . . . are shown to have circular sections for convenience sake but are actually gas discharging thin tubes (plasma tube) made of glass having a vertically long, flattened cross section as described later in detail. The diameter of each glass thin tube to serve as a tube envelope is not particularly limited. Desirably, however, the shorter diameter is 1 mm or less and the longer diameter is approximately 1 to 3 mm. Furthermore, the plasma tubes 31, 31, . . . are filled with a discharge gas mixture such as neon, xenon and the like at a predetermined ratio and a predetermined pressure.

The plasma tubes 31, 31, . . . arranged in parallel are held between an address electrode sheet 33 and a display electrode sheet 35. The address electrode sheet 33 comprises address electrodes 32, 32, . . . arranged in the longitudinal direction of the plasma tubes 31, 31, . . . . The display electrode sheet 35 comprises display electrode pairs (generally X and Y electrodes pair) 34, 34, . . . arranged in the direction substantially orthogonal to the longitudinal direction of the plasma tubes 31, 31, . . . . The display electrode sheet 35 is a flexible sheet and is configured with, for example, a polycarbonate film or a polyethylene terephthalate (PET) film.

A plurality of display electrode pairs 34, 34, . . . are arranged in a stripe pattern in the direction orthogonal to the longitudinal direction of the plasma tubes 31, 31, . . . on the display screen side of the plasma tube array-type display device 30. The display discharge can be generated in the plasma tubes 31, 31, . . . between adjacent display electrodes (X, Y) 34, 34 by applying ac driving voltage therebetween. The display electrodes 34 can be formed using various materials known in the present field. Examples of the materials that are used for the display electrodes 34 include transparent conductive materials such as indium tin oxide (ITO) and SnO₂ as well as metal conductive materials such as Ag, Au, Al, Cu, and Cr with mesh pattern.

Various methods known in the present field can be used for the method of forming the display electrodes 34. For example, they may be formed using a thick-film forming technique such as printing or may be formed using a thin-film forming technique that includes a physical deposition method or a chemical deposition method. Examples of the thick-film forming technique include a screen printing method. Among thin-film forming techniques, examples of the physical deposition method include a vapor deposition method and a sputtering method, while examples of the chemical deposition method include a thermal CVD method, a photo-CVD method, and a plasma CVD method.

The address electrodes 32, 32, . . . each are provided per plasma tube 31 on the rear side of the plasma tube array-type display device 30 along the longitudinal direction of the plasma tubes 31, 31, . . . . The address electrodes 32, 32, . . . define light-emitting cells at intersections with the display electrode pairs 34, 34, . . . and are used for selecting light-emitting cells. The address electrodes 32 also can be formed using various materials and methods that are known in the present field.

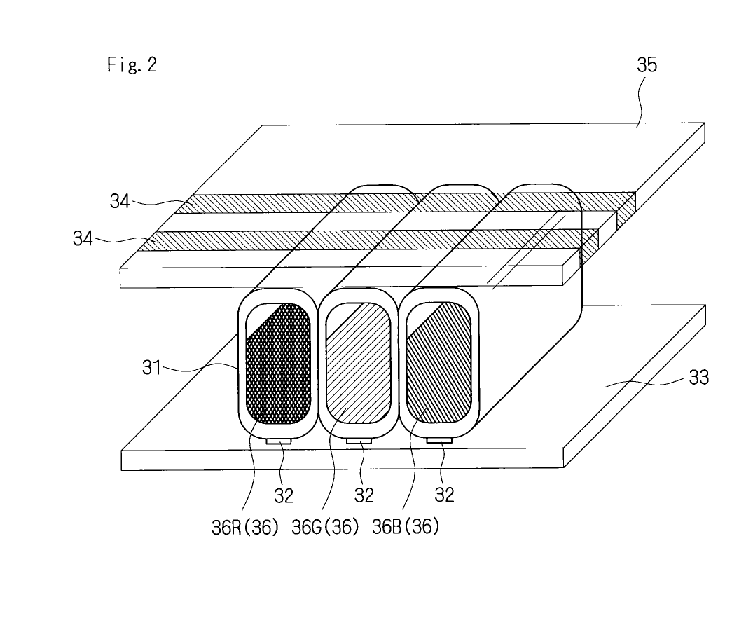

FIG. 2 is an enlarged perspective view partially showing the configuration of the plasma tube array of the plasma tube array-type display device 30 according to Embodiment 1 of the present invention. Since the plasma tube array-type display device 30 is designed to be capable of color display, each plasma tube 31 comprises a red (R) phosphor layer 36R, a green (G) phosphor layer 36G, or a blue (B) phosphor layer 36B, which is formed on the inner wall thereof. When one pixel is composed of one set or unit of plasma tubes 31, 31, and 31 of three colors RGB, the plasma tube array-type display device 30 is capable of color display. In FIGS. 1 and 2, although the address electrodes 32, 32 are arranged on the address electrode sheet 33, they may be formed on a rear surface of the tube wall directly by means of printing and etc. With respect to the phosphor layers 36, a phosphor material such as (Y, Gd)BO₃:Eu³⁺ that emits red light by ultraviolet irradiation generated by a gas discharge is used for the red (R) phosphor layer 36R, a phosphor material such as Zn₂SiO₄:Mn that emits green light is used for the green (G) phosphor layer 36G, and a phosphor material such as BaMgAl₁₂O₁₇:Eu²⁺ that emits blue light is used for the blue (B) phosphor layer 36B.

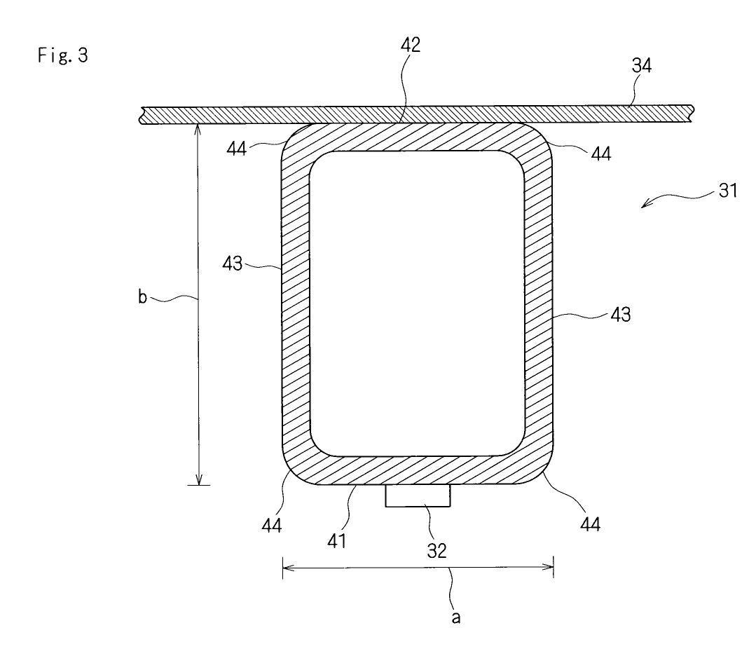

In Embodiment 1, the plasma tubes 31 each have a transverse section orthogonal to the longitudinal direction of a vertically long, flattened shape having its longer diameter vertically. FIG. 3 is a cross-sectional view taken at a plane orthogonal to the longitudinal direction of the plasma tubes 31, 31, . . . of the plasma tube array-type display device 30 according to Embodiment 1 of the present invention.

As shown in FIG. 3, each plasma tube 31 of the plasma tube array-type display device 30 according to Embodiment 1 has a transverse section orthogonal to the longitudinal direction, which has a longer diameter b and a shorter diameter a, of a vertically long, flattened shape having its longer diameter b vertically. For example, in each plasma tube 31, the transverse section orthogonal to the longitudinal direction has four flat surfaces and four curved surfaces 44, 44, . . . connecting the four flat surfaces, respectively, where the four flat surfaces include a first flat surface (a lower flat surface) 41 that is in contact with the address electrode 32, a second flat surface (an upper flat surface) 42 that is in contact with the display electrode 34, and third and fourth flat surfaces (longer diameter side flat surfaces) 43, 43 crossing the arranging direction of the plasma tubes. The transverse section orthogonal to the longitudinal direction has preferably a vertically long, flattened, pseudo-octagonal shape.

The shorter diameter (width) a of the cross section of the plasma tube that defines the pixel width is desirably 1 mm or less from a viewpoint of an increase in resolution. In this case, if the diameter (height) b is less than the diameter a, the amount of phosphors is reduced, which makes it difficult to maintain sufficiently high brightness. Furthermore, when the longer diameter (height) b is longer than triple the shorter diameter a, the distance from the display electrode pair 34 to the phosphor layer 36 becomes relatively long, which increases the attenuation of the ultraviolet radiation generated by discharge and also increases a discharge voltage for addressing between the display electrode 34 and the address electrode 32. Thus, similarly, it becomes difficult to maintain sufficiently high brightness and stable addressing. Therefore, preferably, the shorter diameter a and the longer diameter b have a relationship in the range of 3a>b>a. Such a shape allows the display electrode 34 to be in plane contact with the plasma tube 31 and thereby voltage can be transmitted efficiently into the plasma tube 31. Accordingly, uniform discharge characteristics can be obtained throughout the plasma tubes 31, 31, . . . .

Furthermore, with the first flat surface 41 and the second flat surface 42, the plasma tubes 31 tend not to tip over and are also easy to position in arranging the plasma tubes 31. Accordingly, production costs can be reduced in the production steps for arranging the plasma tubes 31 and attaching the address electrode sheet 33 and the display electrode sheet 35 thereto.

The steps of producing the thin glass tube envelope for plasma tubes 31 with the shape described above are described below. FIGS. 4A, 4B and 4C each are an illustration showing a step of producing the thin glass envelope for the plasma tube 31 of the plasma tube array-type display device 30 according to Embodiment 1 of the present invention.

For example, first, a borosilicate glass mother tube 45 with a diameter of 10 mm in the transverse section, a tube thickness of 1.0 mm, and a length of 500 mm is prepared. Second, both ends of the mother tube 45 are heated and melted to be sealed, with the air being sealed inside. Subsequently, the airtight glass mother tube 45 is placed in a forming jig 46 (see the left-side drawing of FIG. 4A). Preferably, the forming jig 46 has a rectangular cross-section with a size of, for example, 8.6 mm by 11.8 mm, and a length that allows the glass mother tube 45 to be accommodated therein, and is made using ceramics (quartz, aluminum nitride, boron nitride, silicon nitride, silicon carbide, etc.) as its material.

Next, the forming jig 46 with the glass mother tube 45 placed therein is placed in a furnace (not shown), and then the temperature thereof is raised to about 640° C. Thereby, the air contained in the glass mother tube 45 expands to increase the internal pressure while the glass mother tube 45 itself softens. Therefore, the glass mother tube 45 is changed into a shape (with a transverse section of a flattened shape) formed along the shape of the inner surface of the forming jig 46.

The glass mother tube 45 thus changed in shape is cooled while remaining in the forming jig 46 and thereby a glass tube preform 47 with a transverse section of a flattened shape is completed (see the right-side drawing of FIG. 4A). During cooling, the glass mother tube 45 is cooled quicker than the air contained inside of the glass mother tube 45. Therefore, the glass mother tube 45 changed into a flattened shape can maintain its shape.

The glass mother tube 45 may have a diameter that is larger than the height of the inner surface of the forming jig 46 and a size that does not allow it to be accommodated in the forming jig 46. In this case, the forming jig 46 with the glass mother tube 45 placed therein is placed in the furnace (not shown), with the upper lid 46a of the forming jig 46 being separated from the other parts of the forming jig 46. Then with a predetermined pressure 49 applied from the upper side of the upper lid 46a, in the condition which both ends of the glass mother tube 45 are heated and softened by the furnace (see the left-side drawing of FIG. 4B). Thus, the glass mother tube 45 is changed into a shape (with a transverse section of a flattened shape) formed along the shape of the inner surface of the forming jig 46. The glass mother tube 45 thus changed in shape is cooled while remaining in the forming jig 46 and thereby a glass tube preform 47 with a transverse section of flattened shape is completed (see the right-side drawing of FIG. 4B).

Furthermore, using a glass mother tube 48 with a transverse section that has been preformed into a flattened elliptical shape, a glass tube preform 47 with a transverse section of flattened shape may be formed in the similar manner (see FIG. 4C). The glass tube preform 47 thus produced is redrawn in the next step and thereby a glass tube or envelope of plasma tube with a similar cross-section is produced. Subsequently, a phosphor coating process and gas filling process and the like are carried out. Thus, the plasma tube 31 can be produced.

As described above, according to Embodiment 1, the plasma tubes 31 each have a transverse section orthogonal to the longitudinal direction of a vertically long, flattened shape having its longer diameter vertically and are arranged to adjoin each other by their tube walls of longer diameter side to form the plasma tube array-type display device. Therefore, it can secure a sufficiently large area contacting with the display electrode 34 on the second flat surface (upper flat surface) 42 of the plasma tube 31 and thereby stable discharge characteristics can be obtained. In addition, the volume of the plasma tube 31 is not reduced. Accordingly, the amount of phosphors of the phosphor layer 36 to be formed on an inner wall thereof needs not to be substantially reduced. Therefore, it becomes possible to provide the plasma tube array-type display device 30 having high resolution with a pixel size (width of set of RGB 3 tubes) of 3 mm or less while maintaining a certain brightness.

In the case of producing a plasma tube array-type display module with a width of 1 m, when the plasma tube 31 has a shorter diameter a of 0.5 mm, a plasma tube array of 1920 tubes can be configured. This corresponds to an array having 640 pixels in the horizontal direction, with each of the pixels including a set of three colours RGB. Therefore, when two plasma tube array-type display modules with a width of lm are connected to each other laterally, it is possible to display a high-resolution image with 1280 pixels in the horizontal direction. Furthermore, when three plasma tube array-type display modules are connected to each other laterally, a full high-resolution image with 1920 pixels in the horizontal direction can be displayed on a large screen.

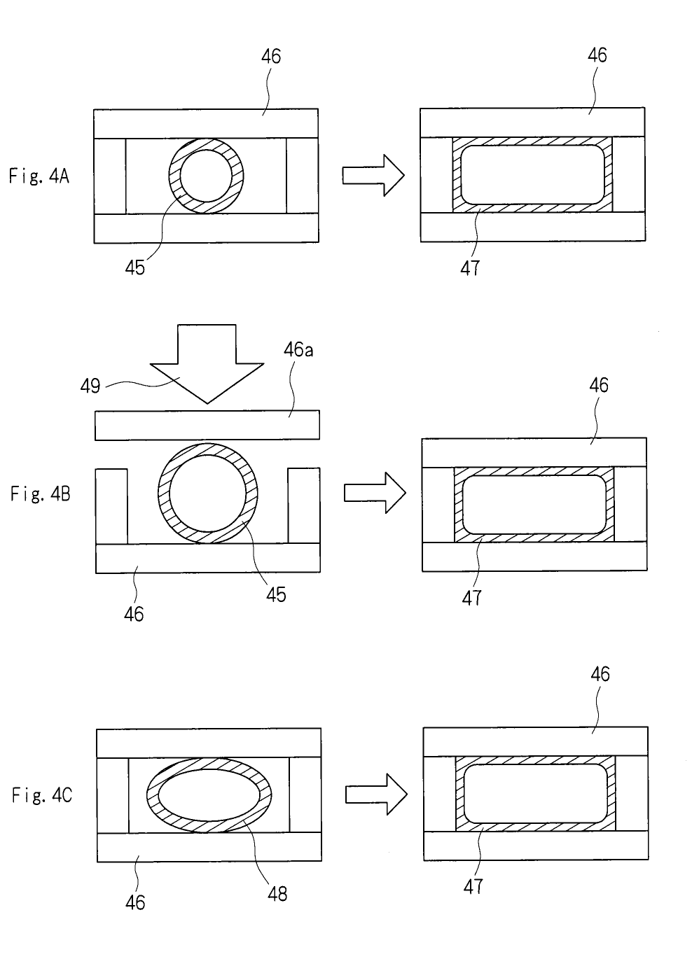

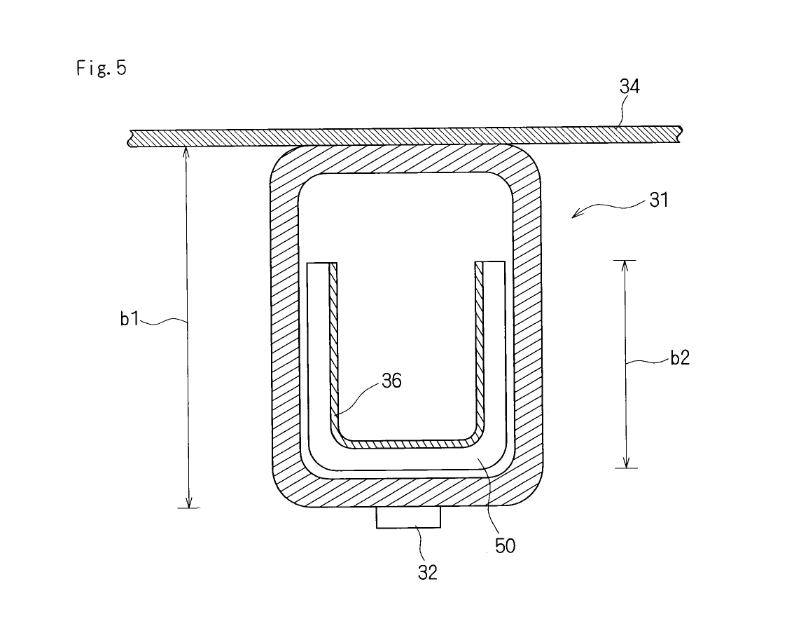

The plasma tubes 31 each may be configured with a phosphor support member (a boat), on which a phosphor layer 36 is formed, inserted in a glass tube. FIG. 5 is a cross-sectional view taken at a plane orthogonal to the longitudinal direction of the plasma tube 31 of the plasma tube array-type display device 30 according to Embodiment 1 of the present invention, with a phosphor support member with a U-shaped cross section being inserted in the plasma tube 31.

As shown in FIG. 5, the phosphor support member 50 has a U-shaped cross section having its address electrode 32 side at the bottom, and the phosphor layer 36 is formed on the inner surface of the phosphor support member 50. The length b2 of the phosphor support member 50 in the longer diameter direction is shorter than the longer diameter b1 of the plasma tube 31 but is preferably at least the half the longer diameter b1, more preferably longer than two-thirds of the longer diameter b1, so that sufficiently high brightness can be maintained.

As another configuration, the phosphor layer 36 may be coated directly on an inner surface as shown in FIG. 2. In this case, the phosphor layer 36, for example, can be formed on the inner surface of the plasma tube 31 after introducing the phosphor slurry in the plasma tube 31.

### Embodiment 2

Since the configuration of a plasma tube array-type display device 30 according to Embodiment 2 of the present invention is similar to that of Embodiment 1, the same numbers and symbols are used and detailed descriptions are not repeated. In Embodiment 2, the plasma tubes 31 each are different from those of Embodiment 1 in that the width of the first flat surface (lower flat surface) 41 that is in contact with the address electrode 32 is narrower than that of the second flat surface (upper flat surface) 42 that is in contact with the display electrode 34.

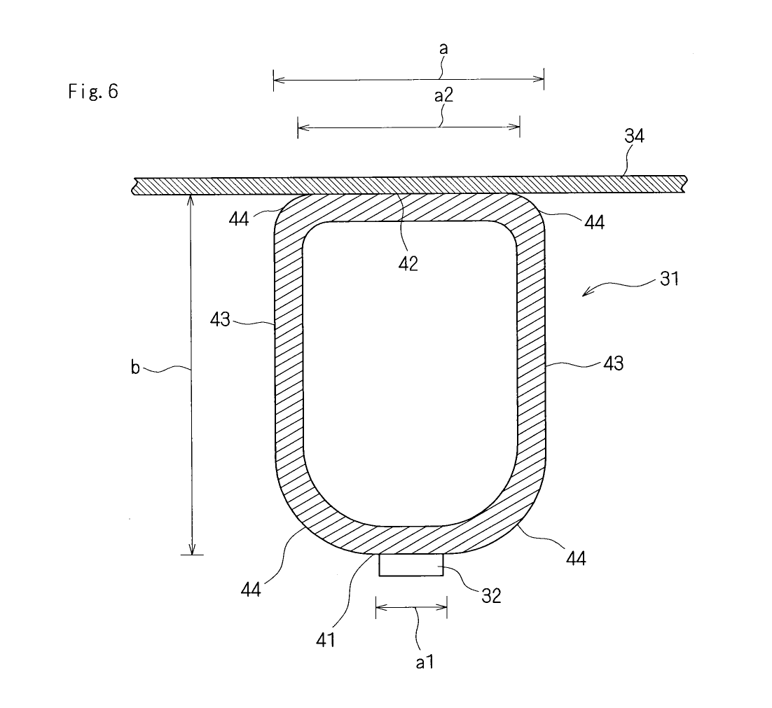

FIG. 6 is a cross-sectional view taken at a plane orthogonal to the longitudinal direction of the plasma tubes 31, 31, . . . of the plasma tube array-type display device 30 according to Embodiment 2 of the present invention. As shown in FIG. 6, each plasma tube 31 of the plasma tube array-type display device 30 according to Embodiment 2 also has a transverse section orthogonal to the longitudinal direction of a vertically long, flattened shape having its longer diameter b vertically.

However, it is different from Embodiment 1 in that the width al of the first flat surface 41 that is in contact with the address electrode 32 is narrower than the width a2 of the second flat surface 42 that is in contact with the display electrode 34. Instead the curved surfaces 44, 44 between the first flat surface 41 and the third and fourth flat surfaces 43, 43 are larger. In Embodiments 1 and 2, the width al of the first flat surface is desirably 20% or more of the shorter diameter a of the plasma tube 31, and the width a2 of the second flat surface that is in contact with the display electrode 34 needs to be wider than the width al of the first flat surface.

An increase in size of the curved surfaces 44, 44 results in an increase in surface area as a whole of the inner wall of the plasma tube 31 on which the phosphor layer 36 is applied as well as an increase in viewing angle. Accordingly, even when a high-resolution plasma tube array-type display device 30 is configured with the shorter diameter a of the plasma tube 31 being shortened, sufficiently high brightness can be maintained.

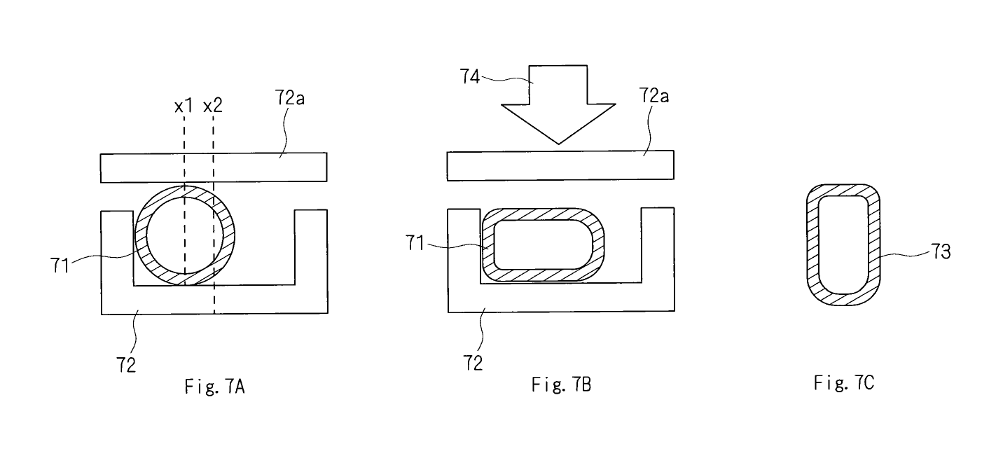

Method for producing the plasma tube 31 shown in FIG. 6 are described below. FIGS. 7A, 7B and 7C each are an illustration showing a step of producing the glass envelope for the plasma tube 31 of the plasma tube array-type display device 30 according to Embodiment 2 of the present invention.

Similarly, as in Embodiment 1, for example, first, a borosilicate glass mother tube 71 with a diameter of 10 mm in the transverse section, a tube thickness of 1.0 mm, and a length of 500 mm is prepared. Second, both ends of the glass mother tube 71 are heated and melted to be sealed, with the air being sealed inside. Subsequently, the airtight glass mother tube 71 is placed in a forming jig 72 (see FIG. 7A). Preferably, the forming jig 72 has a rectangular cross-section.

In this case, the difference from Embodiment 1 is the position where the glass mother tube 71 is placed. In Embodiment 1, it is placed in such a manner that the tube axis of the glass mother tube 45 is positioned substantially at the center of the forming jig 46. On the other hand, in Embodiment 2, it is placed with the tube axis xl of the glass mother tube 71 displaced from the center x2 in the width direction of the forming jig 72 (see FIG. 7A).

The forming jig 72 with the glass mother tube 71 placed therein is placed in a furnace, with the upper lid 72a of the forming jig 72 being separated from other parts of the forming jig 72. Then the glass mother tube 71 is heated in the forming jig 72 so as to soften it, and a fixed pressure 74 is applied from the upper side of the upper lid 72a so as to collapse the glass mother tube 71 (see FIG. 7B). Thus, the glass mother tube 71 is changed into a shape (with a transverse section of a flattened shape) formed along the shape of the flat inner surface of the forming jig 72, on the side to which the tube axis xl of the glass mother tube 71 is displaced (on the left side in the drawing). On the opposite side (on the right side in the drawing), because of the large space between the glass mother tube 71 and inside wall of the forming jig 72, only a part of the right side of the glass mother tube 71 is changed into a shape formed along the shape of the inner surface of the forming jig 72. Thus, the glass mother tube 71 is changed into an asymmetrical shape shown in FIG. 7B.

The glass mother tube 71 is cooled while remaining in the forming jig 72 and thereby a glass tube preform 73 with a transverse section of a vertically long, asymmetrical, flattened shape as shown in FIG. 7C is completed. The glass tube preform 73 is redrawn to be thinned and thereby a glass tube with a similar cross-section is produced. Subsequently, the same production steps as those of Embodiment 1 are carried out. Thus, the plasma tube 31 shown in the FIG. 6 can be produced.

As described above, according to Embodiment 2, the plasma tubes 31 each have a cross section orthogonal to the longitudinal direction in which the width al of the first flat surface 41 that is in contact with the address electrode 32 is narrower than the width a2 of the second flat surface 42 that is in contact with the display electrode 34. This results in an increase in surface area of the inner wall of the plasma tube 31 on which the phosphor layer 36 is formed. Accordingly, even when a high-resolution plasma tube array-type display device 30 is configured with the shorter diameter a of the plasma tube 31 being shortened, sufficiently high brightness can be maintained.

### Embodiment 3

In Embodiment 3, the plasma tubes 31 each have a transverse section orthogonal to the longitudinal direction of a substantially vertically long, flattened, trapezoidal shape and are different from those of Embodiment 1 in the array form in which they are combined together with the upper and lower sides thereof being inverted.

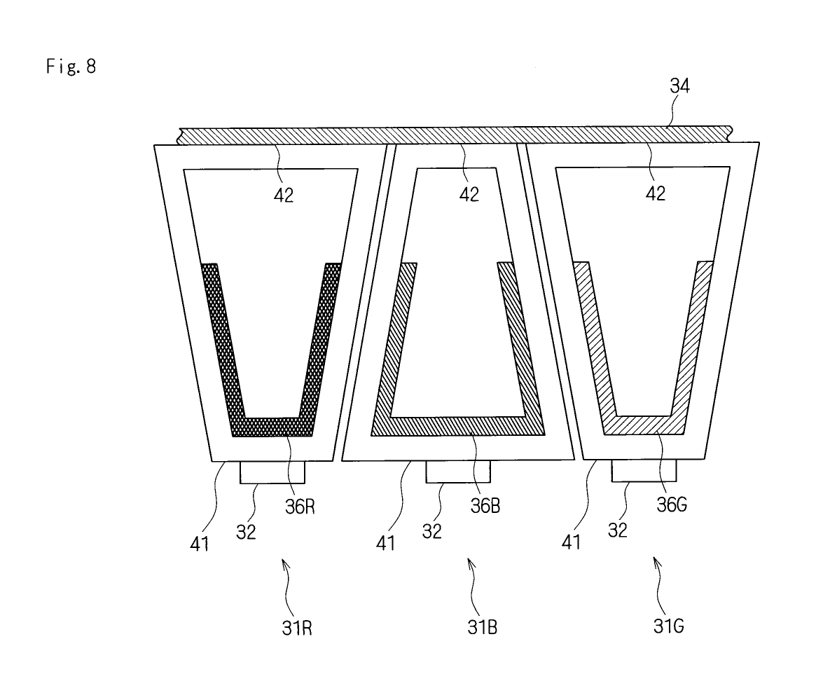

FIG. 8 is a cross-sectional view schematically showing the configuration of a plasma tube unit of a plasma tube array-type display device 30 according to Embodiment 3 of the present invention. In FIG. 8, each plasma tube 31 comprises a red (R) phosphor layer 36R, a blue (B) phosphor layer 36B, or a green (G) phosphor layer 36G on the narrower top side inner surface or a wider bottom side inner surface of the vertically long, flattened, trapezoidal cross section. When a plasma tube unit corresponding to one pixel composed of one set of plasma tubes 31, 31, and 31 of three colors RGB is configured, the plasma tube array-type display device is capable of color display.

In the example shown in FIG. 8, the plasma tube 31R located at the farthest left comprises the red (R) phosphor layer 36R on the narrower top side inner surface. In the red plasma tube 31R, its transverse section orthogonal to the longitudinal direction has a substantially inverted trapezoidal shape with its top part facing downward, the width of the first flat surface 41 that is in contact with the address electrode 32 is narrower than that of the second flat surface 42 that is in contact with the display electrode 34, and the red (R) phosphor layer 36R formed on the narrower top side inner surface of the trapezoid is arranged to be positioned on the address electrode 32 side.

Next, the center plasma tube 31B arranged adjoining the plasma tube 31R comprises the blue (B) phosphor layer 36B on the wider bottom side inner surface. In the blue plasma tube 31B, its transverse section orthogonal to the longitudinal direction has a substantially trapezoidal shape, and the width of the first flat surface 41 that is in contact with the address electrode 32 is wider than that of the second flat surface 42 that is in contact with the display electrode 34. The blue (B) phosphor layer 36B formed on the wider bottom side inner surface of the trapezoid is arranged to be positioned on the address electrode 32 side.

Furthermore, the right-hand plasma tube 31G arranged adjoining the plasma tube 31B comprises the green (G) phosphor layer 36G on the narrower top side inner surface. In the green plasma tube 31G, its transverse section orthogonal to the longitudinal direction has a substantially inverted trapezoidal shape with its top part facing downward, as is the case with the red plasma tube 31R, the width of the first flat surface 41 that is in contact with the address electrode 32 is narrower than that of the second flat surface 42 that is in contact with the display electrode 34, and the green (G) phosphor layer 36G formed on the narrower top side inner surface of the trapezoid is arranged to be positioned on the address electrode 32 side.

Generally, blue has lower brightness. Therefore, when one pixel is simply composed of one set of plasma tubes 31, 31, and 31 of three colours RGB, the smaller the pixel size is, the more the brightness balance tends to be disturbed. However, in the case of the plasma tube 31B with the blue (B) phosphor layer 36B comprised on the wider bottom side, the area of the blue phosphor layer 36B is larger than that of the red phosphor layer 36R and the green phosphor layer 36G. This provides an effect of allowing white brightness of a combination of three colours to be balanced easier.

As described above, according to Embodiment 3, the plasma tube 31 has a transverse section orthogonal to the longitudinal direction of a substantially vertically long, flattened, trapezoidal shape, and a plasma tube array unit is configured with the phosphor layers 36 of three colours arranged to be located on the rear side of the display device, with the blue plasma tube 31B whose cross section has an inverted trapezoidal shape, in which the blue (B) phosphor layer 36B is formed on its inner surface on the wider bottom side, being held between the red plasma tube 31R in which the red (R) phosphor layer 36R is formed on its inner surface on the narrower top side of the trapezoidal cross section and the green plasma tube 31G in which the green (G) phosphor layer 36G is formed on its inner surface on the narrower top side of the trapezoidal cross section, and the area where the blue plasma tube 31B with relatively low brightness emits light is increased. Thus, the white brightness balance is improved and thereby natural color display can be achieved with high resolution.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A plasma tube array-type display device, comprising a plasma tube array that includes a plurality of plasma tubes arranged in parallel, a plurality of address electrodes each provided along a longitudinal direction of the respective plasma tube, and a plurality of display electrodes extending in a direction crossing the plasma tubes, wherein each of the plasma tubes has a transverse section with longer diameter and shorter diameter of a vertically long flattened shape in an orthogonal plane to a longitudinal direction of the plasma tube, and they are arranged to adjoin each other by their tube walls of longer diameter side, to be in contact with the address electrodes by one side of the tube walls of shorter diameter side along the longitudinal direction, and to be in contact with the display electrodes by the other side of the tube walls of shorter diameter side, which is opposite to the one side.

2. The plasma tube array-type display device according to claim 1, wherein the plasma tubes each have the transverse section orthogonal to the longitudinal direction of a vertically long, flattened, pseudo-octagonal shape with four flat surfaces and four curved surfaces connecting the four flat surfaces, respectively, where the four flat surfaces include a first shorter diameter side flat surface that is in contact with the address electrode, a second shorter diameter side flat surface that is in contact with the display electrode, and third and fourth longer diameter side flat surfaces that are opposed to each other in an arranging direction of the plasma tubes.

3. The plasma tube array-type display device according to claim 2, wherein each of the plasma tubes with the transverse section of the vertically long, flattened, pseudo-octagonal shape have the first shorter diameter side flat surface narrower in width than the second shorter diameter side flat surface in the transverse section orthogonal to the longitudinal direction.

4. The plasma tube array-type display device according to claim 1, wherein the plasma tubes each have a transverse section orthogonal to the longitudinal direction of a substantially vertically long, flattened, trapezoidal shape, a plasma tube set is composed in such a manner that a red plasma tube containing a red (R) phosphor on a narrower top side inner surface which is arranged downward, a blue plasma tube containing a blue (B) phosphor on a wider bottom side inner surface, and a green plasma tube containing a green (G) phosphor on a narrower top side inner surface which is arranged downward, are arranged to adjoin one another with respective phosphors being located on the same side, and a plurality of plasma tube sets are arranged to compose each plasma tube array.

5. The plasma tube array-type display device according to claim 2, wherein the plasma tubes each have a transverse section orthogonal to the longitudinal direction of a substantially vertically long, flattened, trapezoidal shape, a plasma tube set is composed in such a manner that a red plasma tube containing a red (R) phosphor on a narrower top side inner surface which is arranged downward, a blue plasma tube containing a blue (B) phosphor on a wider bottom side, and a green plasma tube containing a green (G) phosphor on a narrower top side inner surface which is arranged downward, are arranged to adjoin one another with respective phosphors being located on the same side, and a plurality of plasma tube sets are arranged to compose each plasma tube array.

6. The plasma tube array-type display device according to claim 1, wherein the plasma tubes each comprise a phosphor support member inserted in a glass tube having a transverse section of a vertically long, flattened shape, which supports the red (R), green (G) or blue (B) phosphor, and the phosphor support member has a U-shaped cross section that has an opening at a position higher than two-thirds the height from the bottom surface of the glass tube.

7. The plasma tube array-type display device according to claim 2, wherein the plasma tubes each comprise a phosphor support member inserted in a glass tube having a transverse section of a vertically long, flattened shape, which supports the red (R), green (G) or blue (B) phosphor, and the phosphor support member has a U-shaped cross section that has an opening at a position higher than two-thirds the height from the bottom surface of the glass tube.

8. The plasma tube array-type display device according to claim 3, wherein the plasma tubes each comprise a phosphor support member inserted in a glass tube having a transverse section of a vertically long, flattened shape, which supports the red (R), green (G) or blue (B) phosphor, and the phosphor support member has a U-shaped cross section that has an opening at a position higher than two-thirds the height from the bottom surface of the glass tube.

9. The plasma tube array-type display device according to claim 4, wherein the plasma tubes each comprise a phosphor support member inserted in a glass tube having a transverse section of a vertically long, flattened shape, which supports the red (R), green (G) or blue (B) phosphor, and the phosphor support member has a U-shaped cross section that has an opening at a position higher than two-thirds the height from the bottom surface of the glass tube.

10. The plasma tube array-type display device according to claim 1, wherein a shorter diameter a of the transverse section of each of the plasma tubes in the arranging direction of the plasma tubes is 1 mm or less, and the shorter diameter a and a longer diameter b have a relationship of 3a>b>a.

11. The plasma tube array-type display device according to claim 2, wherein a shorter diameter a of the transverse section of each of the plasma tubes in the arranging direction of the plasma tubes is 1 mm or less, and the shorter diameter a and a longer diameter b have a relationship of 3a>b>a.

12. A plasma tube array-type display device, comprising a plurality of plasma tubes arranged in parallel, each of which has a shape of flattened, vertically long cross section with a shorter diameter side opposed to two flat surfaces and a longer diameter side opposed to two flat surfaces in an orthogonal plane to a longitudinal direction of the plasma tube, wherein
a first shorter diameter side flat surface of the plasma tube contacts with address electrodes,
a second shorter diameter side flat surface of the plasma tube contacts with a plurality of display electrodes, and
third and fourth longer diameter side flat surfaces of the plasma tube are arranged adjoining with the longer diameter side flat surfaces of the other plasma tubes in arranging direction.

13. The plasma tube array-type display device according to claim 12, wherein a shorter diameter a of the transverse section of each of the plasma tubes in the arranging direction of the plasma tubes is 1 mm or less, and the shorter diameter a and a longer diameter b have a relationship of 3a>b>a.
